(19) United States
(12) Patent Application Publication
(10) Pub. No.: US 2014/0074517 A1
(43) Pub. Date: Mar. 13, 2014

(54) Multi-Carrier Interface System

(71) Applicant: Security Mutual Life Insurance Company of New York, Binghamton, NY (US)

(72) Inventors: Scott A. Sylvester, Endicott, NY (US); Oliver T. Hicks, Binghamton, NY (US)

(73) Assignee: Security Mutual Life Insurance Company of New York, Binghamton, NY (US)

(21) Appl. No.: 14/016,867

(22) Filed: Sep. 3, 2013

Related U.S. Application Data
(60) Provisional application No. 61/699,656, filed on Sep. 11, 2012.

(51) Int. Cl. G06Q 40/08

(52) U.S. Cl. CPC G06Q 40/08
USPC 705/4

(57) ABSTRACT

The present inventive subject matter is drawn to apparatus, systems, configurations, and methods of automatically interfacing with different proprietary insurance administration systems. In one aspect of the invention, an insurance management system is configured to automatically receive, convert, and transmit customer data from an intermediary data format to proprietary data formats associated with different insurance administration systems.

This application claims the benefit of U.S. provisional application No. 61/699,656, filed Sep. 11, 2012. These and all other referenced extrinsic materials are incorporated herein by reference in their entirety. Where a definition or use of a term in a reference that is incorporated by reference is inconsistent or contrary to the definition of that term provided herein, the definition of that term provided herein is deemed to be controlling.

### FIELD OF THE INVENTION

The present invention relates to methods and systems for interfacing with multiple proprietary insurance administration systems.

### BACKGROUND

The following description includes information that may be useful in understanding the present invention. It is not an admission that any of the information provided herein is prior art or relevant to the presently claimed invention, or that any publication specifically or implicitly referenced is prior art.

Insurance carriers have long used computer systems to assist in their operations. Such computer systems are generally known as insurance administration systems, and usually perform multiple functions for the insurance carriers. For example, some insurance administration systems include a quoting engine that automatically generates insurance quotations based on a set of parameters. For more complicated insurance policies that require manual underwriting, some insurance administration systems include an underwriting system for tracking and assisting underwriters of the insurance carriers while they underwrite different risks. Some insurance administration systems also include a claim administration system for handling and administering insurance claims or a customer relationship management system for storing customers' information.

In addition, some of these insurance administration systems offer an interface to communicate with insurance agents/brokers and customers. However, since each insurance carrier has different requirements for using the insurance data and different desired functionalities for the computer systems, it is very common for each insurance carrier to develop a proprietary insurance administration system. However, each proprietary insurance administration system may have a different interface for communicating with external systems and may use a different format to represent insurance data. Furthermore, the insurance data that is stored on one insurance administration system may not be compatible with the insurance data that is stored on another insurance administration system as the two insurance administration systems use completely different formats to represent the insurance data. As a result, it is very difficult to efficiently interface with different proprietary insurance administration systems. An insurance broker, for example, may have to repetitiously enter the same insurance data into different insurance administration systems in slightly different ways order to obtain insurance quotations from different insurance carriers.

Efforts have been made in developing a universal electronic data format for storing and representing insurance data. For example, the ACORD XML format has become the de facto data format in the insurance industry. U.S. patent publication 2011/0119574 to Rogers et al., titled “System and Method for Translating Insurance-related Data”, filed Nov. 13, 2009, also discloses a computer system for mapping insurance data from a proprietary format to the ACORD XML format. All publications herein are incorporated by reference to the same extent as if each individual publication or patent application were specifically and individually indicated to be incorporated by reference. Where a definition or use of a term in an incorporated reference is inconsistent or contrary to the definition of that term provided herein, the definition of that term provided herein applies and the definition of that term in the reference does not apply.

However, so long as most insurance carriers still use their own proprietary administration systems and do not store, there remains a need for a system that automatically interfaces with different proprietary insurance administration systems.

All publications herein are incorporated by reference to the same extent as if each individual publication or patent application were specifically and individually indicated to be incorporated by reference. Where a definition or use of a term in an incorporated reference is inconsistent or contrary to the definition of that term provided herein, the definition of that term provided herein applies and the definition of that term in the reference does not apply.

In some embodiments, the numbers expressing quantities of ingredients, properties such as concentration, reaction conditions, and so forth, used to describe and claim certain embodiments of the invention are to be understood as being modified in some instances by the term “about.” Accordingly, in some embodiments, the numerical parameters set forth in the written description and attached claims are approximations that can vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the invention are approximations, the numerical values set forth in the specific examples are reported as precisely as practicable. The numerical values presented in some embodiments of the invention may contain certain errors necessarily resulting from the standard deviation found in their respective testing measurements.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

The recitation of ranges of values herein is merely intended to serve as a shorthand method of referring individually to each separate value falling within the range. Unless otherwise indicated herein, each individual value is incorporated into the specification as if it were individually recited herein. All methods described herein can be performed in any suitable order unless otherwise indicated herein or otherwise clearly contradicted by context. The use of any and all examples, or exemplary language (e.g. “such as”) provided with respect to certain embodiments herein is intended merely to better illuminate the invention and does not pose a limitation on the scope of the invention otherwise claimed. No language in the specification should be construed as indicating any non-claimed element essential to the practice of the invention.

Groupings of alternative elements or embodiments of the invention disclosed herein are not to be construed as limitations. Each group member can be referred to and claimed individually or in any combination with other members of the group or other elements found herein. One or more members of a group can be included in, or deleted from, a group for reasons of convenience and/or patentability. When any such inclusion or deletion occurs, the specification is herein deemed to contain the group as modified thus fulfilling the written description of all Markush groups used in the appended claims.

### SUMMARY OF THE INVENTION

The present inventive subject matter is drawn to apparatus, systems, configurations, and methods of automatically interfacing with different proprietary insurance administration systems. In one aspect of this invention, a method for interfacing with a plurality of insurance administration systems is presented.

In some embodiments, the method for interfacing with a plurality of insurance administration systems is configured to automatically receive insurance data from a customer, store the insurance data in an intermediary format, and interface with the plurality of insurance administration systems by automatically (i) converting the insurance data from the intermediary format to a plurality of different proprietary formats, each of the plurality of different proprietary formats corresponding to a different insurance administration system and (ii) sending the insurance data to the plurality of insurance administration systems in their corresponding formats. In some embodiments, the intermediary format may be a JavaScript Object Notation (JSON) format, or may be an Extensible Markup Language (XML) format in other embodiments.

In some embodiments, each of the insurance administration systems is associated with a different insurance carrier. Additionally, at least one of the insurance administration systems may comprise an insurance quoting engine for obtaining quotations of the associated carrier's insurance policies. In other embodiments, at least one of the insurance administration systems may comprise a customer relationship management system. Further, in some other embodiments, at least one of the insurance administration systems may comprise an insurance underwriting system.

In some embodiments, converting the insurance data comprises appending a subset of insurance data to another subset of insurance data. Converting the insurance data may also comprise rearranging an order of the insurance data in other embodiments.

In some embodiments, the insurance data may be received from a remote device over a network. The insurance data may be received in a generic format in other embodiments. Further, the insurance data may also comprise information related to the customer's preferences on insurance products.

In some embodiments, the method for interfacing with a plurality of insurance administration systems may be also configured to automatically querying a set of relevant insurance products from the plurality of insurance administration systems based on the insurance data received from the customer.

In another aspect of the invention, a system for interfacing with a plurality of insurance administration systems is presented. In some embodiments, the system for interfacing with a plurality of insurance administration systems comprises a data storage, a network interface configured to communicate with a plurality of insurance administration systems, and a processor coupled with the data storage and the network interface, the processor may be configured to (i) store insurance data received from customers in the data storage in an intermediary format, (ii) automatically convert the insurance data from the intermediary format to a plurality of different proprietary formats, each of the plurality of different proprietary formats corresponding to a different insurance administration system in the plurality of insurance administration systems, and (iii) send the insurance data to the plurality of insurance administration systems in their corresponding propriety formats via the network interface.

In some embodiments, the processor may be configured to convert the insurance data by appending a subset of insurance data to another subset of insurance data. The processor may also be configured to convert the insurance data by rearranging an order of the insurance data in other embodiments. In yet another embodiment, the processor may be configured to automatically query a set of relevant insurance products from the plurality of insurance administration systems based on the insurance data received from the customer.

Various objects, features, aspects and advantages of the inventive subject matter will become more apparent from the following detailed description of preferred embodiments, along with the accompanying drawing figures in which like numerals represent like components.

### BRIEF DESCRIPTION OF THE DRAWINGS

FIG. 1 illustrates an example computing environment in which an insurance management system interacts with user computers and different proprietary insurance administration systems.

FIG. 2 illustrates an example insurance management system of some embodiments.

FIG. 3 illustrates a process for interfacing with different insurance administration systems.

FIG. 4 illustrates a process for presenting response data received from the insurance administration systems to a user.

### DETAILED DESCRIPTION

It should be noted that any language directed to a computer should be read to include any suitable combination of computing devices, including servers, interfaces, systems, databases, agents, peers, engines, modules, controllers, or other types of computing devices operating individually or collectively. One should appreciate the computing devices comprise a processor configured to execute software instructions stored on a tangible, non-transitory computer readable storage medium (e.g., hard drive, solid state drive, RAM, flash, ROM, etc.). The software instructions preferably configure the computing device to provide the roles, responsibilities, or other functionality as discussed below with respect to the disclosed apparatus. In especially preferred embodiments, the various servers, systems, databases, or interfaces exchange data using standardized protocols or algorithms, possibly based on HTTP, HTTPS, AES, public-private key exchanges, web service APIs, known financial transaction protocols, or other electronic information exchanging methods. Data exchanges preferably are conducted over a packet-switched network, the Internet, LAN, WAN, VPN, or other type of packet switched network.

The following discussion provides many example embodiments of the inventive subject matter. Although each embodiment represents a single combination of inventive elements, the inventive subject matter is considered to include all possible combinations of the disclosed elements. Thus if one embodiment comprises elements A, B, and C, and a second embodiment comprises elements B and D, then the inventive subject matter is also considered to include other remaining combinations of A, B, C, or D, even if not explicitly disclosed.

The following description includes information that may be useful in understanding the present invention. It is not an admission that any of the information provided herein is prior art or relevant to the presently claimed invention, or that any publication specifically or implicitly referenced is prior art.

In some embodiments, the numbers expressing quantities of ingredients, properties such as concentration, reaction conditions, and so forth, used to describe and claim certain embodiments of the invention are to be understood as being modified in some instances by the term “about.” Accordingly, in some embodiments, the numerical parameters set forth in the written description and attached claims are approximations that can vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the invention are approximations, the numerical values set forth in the specific examples are reported as precisely as practicable. The numerical values presented in some embodiments of the invention may contain certain errors necessarily resulting from the standard deviation found in their respective testing measurements.

As used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously.

Unless the context dictates the contrary, all ranges set forth herein should be interpreted as being inclusive of their endpoints, and open-ended ranges should be interpreted to include commercially practical values. Similarly, all lists of values should be considered as inclusive of intermediate values unless the context indicates the contrary.

The present inventive subject matter is drawn to apparatus, systems, configurations, and methods of automatically interfacing with different proprietary insurance administration systems. In one aspect of the invention, an insurance management system is presented. In some embodiments, the insurance management system is configured to automatically interface with different proprietary insurance administration systems.

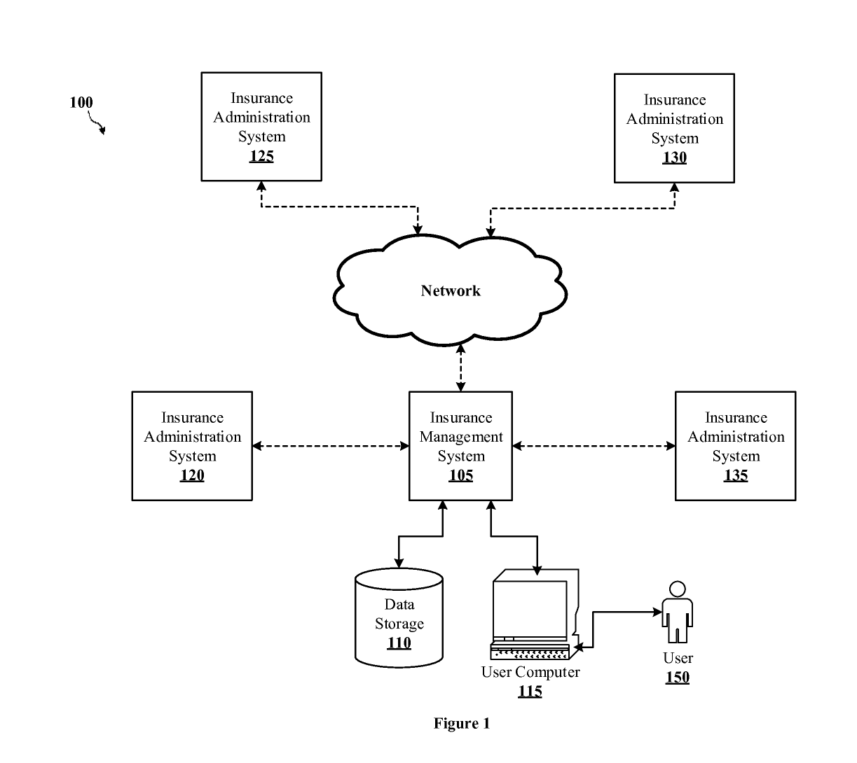

FIG. 1 illustrates an example computing environment in which an insurance management system interacts with user computers and different proprietary insurance administration systems. As shown, an insurance management system 105 is communicatively coupled with a data storage 110. The insurance management system 105 is also communicatively coupled with several different insurance administration systems 120-135, as well as a user computer 115. In some embodiments, the insurance management system may be operated and administered by an insurance brokerage firm who acts as a middleman between insurance products consumers and insurance carriers. The insurance management system may assist in facilitating communication and transfer of data between consumers and carriers.

In some embodiments, the data storage 110 may be a permanent data storage such as a hard drive, a flash memory, etc. The data storage 110 may store insurance data received from the customers and information for converting data between different formats (e.g., mapping tables, lookup tables, mathematical algorithms, Extensible Markup Language (XML) schema files, etc). The data storage 110 in some embodiments may be fully integrated with the insurance management system 105. In other embodiments, the data storage 110 may be partially or totally setup separately from the insurance management system 105, and may be communicatively coupled with the insurance management system 105 over a network (e.g., a Local Area Network (LAN), a Wide Area Network (WAN), the Internet, etc.).

In some embodiments, the user computer 115 may be operated by a user 150 (e.g., an insurance broker, a consumer, etc.) who has an interest in communicating information with multiple insurance carriers. The user computer 115 may communicate with the insurance management system 105 over a network. The insurance management system 105 may also be communicatively coupled with several insurance administration systems 120-135. In some embodiments, at least some of the insurance administration systems (120-135) are associated with the same insurance carrier. In these embodiments, the insurance administration systems of the carrier perform different functions for the carrier.

The user computer 115 may be operated by an insurance broker. In these embodiments, the insurance broker may receive requests from an end-consumer or other interested parties. Thereupon the insurance broker may utilize the user computer 115 to interface with the insurance management system 105 to obtain the desired insurance or other information. The user computer 115 may be directly integrated with the insurance management system 105, or may be connected over a LAN. In these embodiments, the insurance management system 105 and the user computer 115 may be setup in an internal network (e.g. LAN) of an insurance brokerage company. Also, one or more of the insurance administration systems 120-135 of different insurance carriers may be connected to the insurance management system 105 of the insurance brokerage company over the Internet. In other embodiments, the user computer 115 may be connected to the insurance management system 105 over the WAN or the Internet.

The user computer 115 may also be operated by an end-consumer. In these embodiments, the end-consumer may utilize the user computer 115 to interface with the insurance management system 105 to obtain insurance or other information. The user computer 115 may be connected to the insurance management system 105 over the Internet.

In addition to user computers, the insurance management system 105 may be communicatively coupled with one or more of the insurance administration systems 120-135 over a LAN of the insurance carrier in some of these embodiments. In other embodiments, the insurance management system 105 may be setup in the LAN of an insurance brokerage company, and may be connected to the different insurance administration systems 120-135 of different insurance carriers or over the Internet.

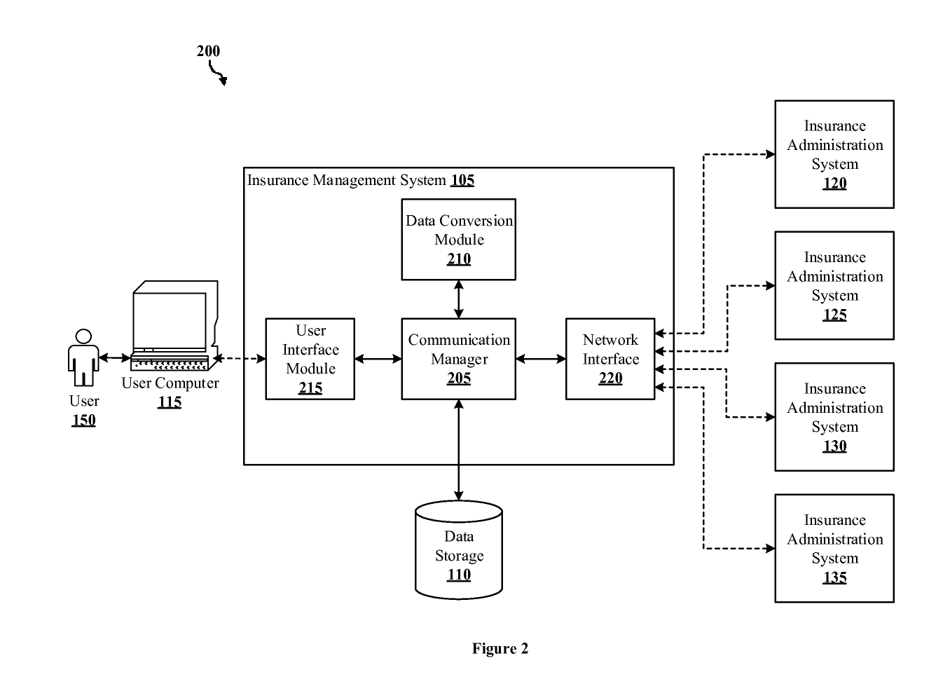

FIG. 2 illustrates an example insurance management system of some embodiments. As shown, the insurance management system 105 may include a communication manager 205, a data conversion module 210, a user interface module 215, and a network interface 220.

In some embodiments, the communication manager 205, the data conversion module 201, the user interface module 215, and the network interface 220 may be implemented as software modules that can be executed by at least one processing unit (e.g., a processor, a processing core, etc.) of the insurance management system 105 to perform different functions.

In some embodiments, the insurance management system 105 may be implemented as computer software that is installed on a computer system operated by an insurance brokerage firm. In other embodiments, the insurance management system 105 may be implemented as a service that may that is accessible by one or more insurance brokerage firms over a network (e.g., the Internet). In these embodiments, the insurance management system 105 may also include a World Wide Web (WWW) Server, through which a consumer or an insurance broker may access the service(s) provided by the insurance management system 105 over the Internet. In yet other embodiments, the insurance management system 105 may be implemented as a WWW Application, which the customer or insurance broker may access using a WWW Browser over the Internet.

As shown, the insurance management system 105 is communicatively coupled with a data storage 110. As mentioned, the data storage 110 in some embodiments may be integrated with the same set of devices on which the insurance management system 105 is installed. In other embodiments, the data storage 110 may be physically removed from the insurance management system 105, and the insurance management system 105 may communicate with the data storage 110 over a network. (e.g. a LAN, a WAN, the Internet, etc.)

The insurance management system 105 is also communicatively coupled with at least one user computer 115. In some embodiments, the communication manager 205 may instruct the user interface module 215 to provide a graphical user interface (GUI) through which the user 150 who uses the user computer 115 may interact with the insurance management system 105.

In addition to the user computer 115, the insurance management system 105 is also shown to be communicatively coupled with several different insurance administration systems 120-135 that are operated by one or more insurance carriers. Different insurance carriers often times develop their own proprietary insurance administration systems, which are incompatible with one another. For example, each of the insurance administration systems 120-135 stores, processes, and communicates insurance data in a particular proprietary format that are incompatible with the formats used by other insurance administration systems and external systems.

A data format defines how data is being represented. It is noted that many formats represent insurance data may according to a key-value pair system. For example, to represent a name of the customer in a first format, the insurance data may include the following key value pairs: <first name: John> and <last name: Doe>. To represent a particular product in the first format, the insurance data may include the following key value pairs: <product type: Life Insurance> and <product name: Flexible Premium Adjustable Universal Life Insurance>. The above represents one particular format to represent the customer and product data under the key-value pair system. The same data, however, can be represented in different formats. For example, in a different second format, the customer data can be represented as: <name: John Doe>, and the product data can be represented as: <product type: 01> and <product code: 10023>.

As shown, the second format differs from the first format in different ways. In this example, the first format uses two different key-value pairs (i.e., first name, and last name) to represent the full name of the customer, while the second format uses only one key-value pair (i.e., name). The key “term” that is associated with each data is also different (e.g., name vs. first name and last name, produce code vs. product name, etc.). In addition, the first format represents the product data using the full name of the product, while the second format represents the product data using a produce code. In some embodiments, the correlation between product codes and products can be unique (proprietary) among the carriers.

In addition to file formats, an insurance carrier may represent insurance data in a database format, such as a Microsoft SQL Server Database format, a MySQL database format, or even a proprietary database format developed specifically for the insurance carrier.

As mentioned, since each of the insurance administration systems 120-135 is developed independently by a different insurance carrier, often times they employ different technologies and/or data formats with each other. As shown, different proprietary formats can be different in ways that they become incompatible. As a result, each insurance administration system may have to use a different proprietary format in representing insurance data, and may have a different interface for communicating with other systems. In some embodiments, the insurance management system 105 uses information as provided by the different insurance administration systems 120-135, and may store such information in the data storage 110 to convert insurance data to each proprietary format and to interact with each of the insurance administration systems 120-135.

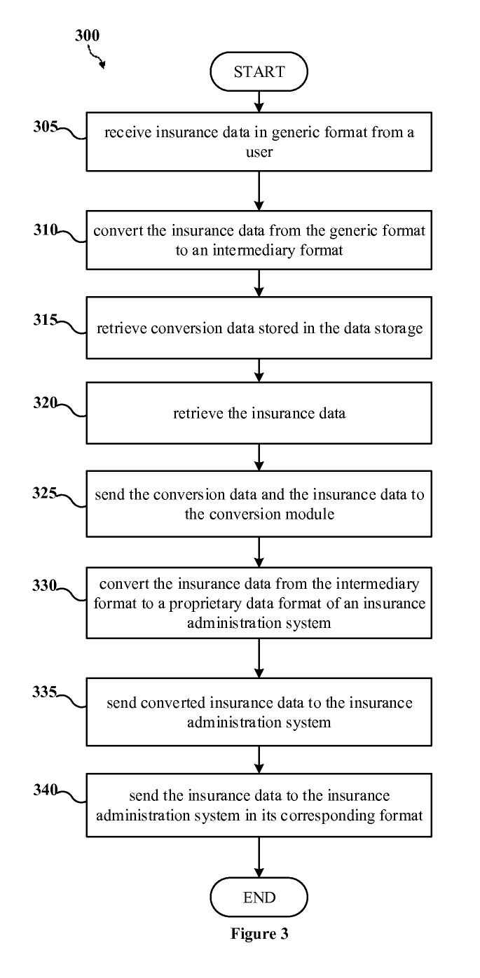

FIG. 3 outlines a preferred embodiment of a process for interfacing with different insurance administration systems. The process 300 will now be described by reference to FIG. 2. Upon the user 150 making inquiries of the insurance management system 105 regarding insurance products and other information through the user computer 115, the user 150 may transmit, and the insurance management system 105 may receive insurance data from the user 150, in step 305. In some embodiments, the insurance management system 105 may prompt the user 150 for the user's personal data (e.g., name, contact information, age, gender, health conditions, etc.), user's medical history, insurance claim history, data related to the user's preference on insurance products (e.g., price preferences, coverage preferences, benefits preferences, etc.) (collectively “insurance data”). This data allows the insurance management system 105 to request for insurance products or other information (e.g., insurance quotations from several insurance carriers), retrieve insurance history and claim information, and other insurance-related services for the user 150. Through the GUI provided by the user interface module 215, the insurance management system 105 may also allow the user 150 to provide the insurance data in different formats (referred to as customer generic formats). For example, the GUI can provide text fields that allow the user 150 to enter insurance data in a text format; the GUI can also provide an upload capability that allows the user 150 to send the insurance data in a certain file format, such as the plain text file format, the Microsoft Word® document file format, or other generic XML formats.

After receiving the insurance data from the user 150 via the user computer 115, the communication manager 205 may store the insurance data in the data storage 110. As mentioned, the insurance data may be received in a generic format (e.g., plain text format) from the user 150. Thus, in some embodiments the communication manager 205 may instruct the data conversion module 210 to convert the insurance data from the customer generic format to an intermediary format as in step 310. In some embodiments, the insurance data may be stored in the data storage 110 in the intermediary data formats, which allows the insurance management system 105 to efficiently organize and retrieve relevant data when needed. Examples of the intermediary data formats may include JavaScript Object Notation (JSON) data format, XML data format, etc.

In some embodiments, the insurance management system 105 may also store information (i.e., conversion data) for converting insurance data from the intermediary data format to each of the proprietary data formats used by the insurance administration systems 120-135 in the data storage 110. The conversion data in some embodiments may include mapping tables, lookup tables, mathematical algorithms, XML schema files, etc. In some embodiments, converting the data from the intermediary format to a proprietary format may include one or more of the following: converting a key term of a data value to a different key term (e.g., converting from <product name> to <product code>, etc.), translating a universally recognizable name to a proprietary code or code name (e.g., translating from a product name of “Flexible Premium Adjustable Universal Life Insurance” to a product code of “10023”, etc.), appending a subset of insurance data to another subset of insurance data (e.g., appending the values of <first name> and <last name> to form a value for the key <name>, splitting a data value that corresponds to a key into values corresponding to two or more keys (e.g., splitting the value for <name> into its <first name> and <last name> values, etc.), rearranging the order of the insurance data, and populating a database table with insurance data.

In some embodiments, the communication manager 205 may access and retrieve the conversion data, and insurance data, in preparation for converting the insurance data from the intermediary format to each of the proprietary data formats used by the respective insurance administration systems 120-135 as illustrated in steps 315 and 320. The insurance management system 105 may then send the conversion data and insurance data to the data conversion module 210 in step 325. In step 330 the data conversion module 210 may convert the insurance data from the intermediary format to a proprietary data format associate with an insurance administration system, using the conversion data.

For example, in some embodiments, the intermediary data format may not exactly match the data format used by a given insurance administration system. Thus, the conversion module 210 may utilize conversion data that specifically describe the proprietary data format used by this insurance administration system to reformat a given set of personal and insurance related data to adhere to the data format used, for this given set to be transmitted and used properly by the insurance administration system. The differences in the data format used between the systems may include the different display and/or storage of date fields (e.g. “Monday Aug. 5, 2013” or “Aug. 5, 2013” or “2013/08/05”), numeric fields (e.g. “100.00” or “100” or “100.000”), a full name fields (e.g. “Joe Smith” or “Smith, Joe” or “Joe M Smith”), etc. The conversion module 210 will know that the insurance administration system expects a date field to be transmitted in the format “Aug. 5, 2013” for example, and will convert a date field from the intermediary format of “Monday Aug. 5, 2013” to the desired format for transmission. The same process applies to numeric fields, name fields, etc.

In other embodiments, the differences between the systems may be that some systems use different sets of data fields. In these embodiments, the conversion module 210 will utilize conversion data that describe the data field types and/or names used by a given insurance administration system. The conversion module 210 may then rearrange the personal and insurance related data in the exact field selection and/or order used by this given insurance management system. Thereby, the converted data will be correctly read and used by the same insurance administration system when transmitted.

For example, the user's 150 mailing address information of may be stored in the intermediary format, which includes the following fields: Address1, Address2, City, State, Zip, and Country. If the insurance administration system expects the user's 150 mailing address information to be transmitted in a data set that include the fields: Street Address, City, State, Zip, Zip Extension, then the conversion module 210 will map (rearrange and/or reformat) the data fields of the intermediary format to match the specific proprietary format for this insurance administration system. The conversion module 210 may combine fields “Address1” and “Address2” to be stored in one field named “Street Address.” Also, the conversion module 210 may divide the field “Zip” of the intermediary formatted data to fit into two different fields named “Zip” and “Zip Extension” in preparation for transmission. Finally in this example, the conversion module 210 will exclude the field “Country” from the new field set prepared to be transmitted over to the insurance administration system.

Thereafter, the communication manager 205 may transmit the converted insurance data to the corresponding insurance administration systems 120-135 via the network interface 220, as in step 335. In some embodiments, the network interface 220 may be an Ethernet interface (in compliance with the 802.3 standards) or a wireless interface (in compliance with the 802.11 standards), which allows the insurance management system 105 to communicate with the insurance administration systems 120-135 over a network (e.g., the Internet).

In some embodiments, the insurance administration system may include an insurance quoting engine for automatically generating insurance quotations based on a set of parameters. The insurance administration system of some embodiments may also include an underwriting module and a customer relationship module. The underwriting module helps the insurance carrier to manage and underwrite complicated risks that require substantial underwriting procedures such as inspection, appraisal, etc. In addition, some insurance administration system 120 may also include a customer relationship management module. The customer relationship management module retains customers' information (e.g., preferences, insurance history, etc.) for future processing. The insurance administration system may also include a network interface to communicate with the insurance management system in some embodiments.

In some embodiments, the communication manager 205 may send the converted insurance data to the insurance administration systems 120-135 as part of a request for additional information, such as insurance quotations, claims information, insurance history, etc. As such, the insurance administration systems 120-135 of some embodiments will utilize modules (e.g. insurance quotation module, underwriting module, etc.) to process the insurance data of the request, to produce a set of responses to be sent back to the insurance management system 105.

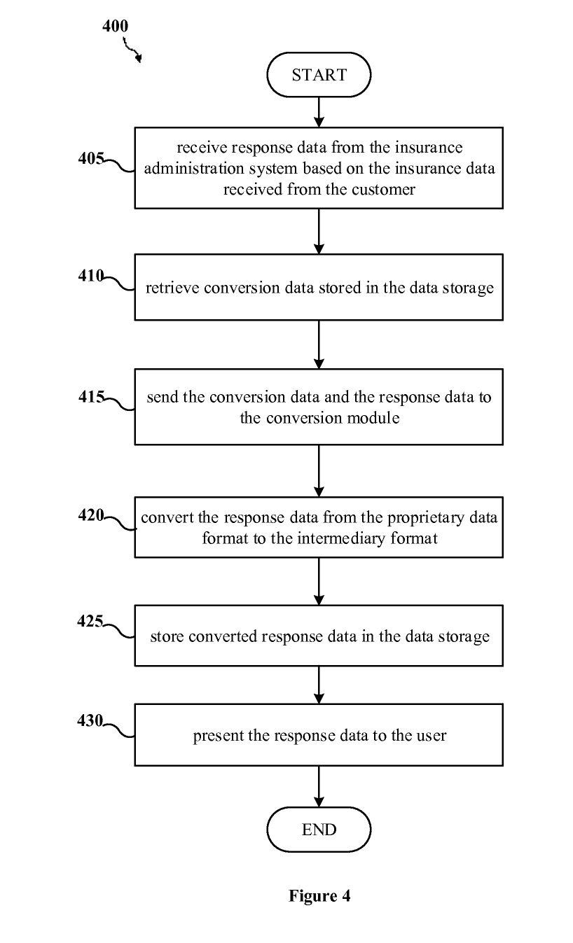

FIG. 4 illustrates a method for processing response data received from an insurance administration system, and presenting the response data to a user. The process 400 will now be described by reference to FIG. 2. In step 405 the insurance management system 105 receives response data from an insurance administration system. In some embodiments, the communication manager 205 may receive the response data from the insurance administration systems 120-135 via the network interface 220.

As shown, the insurance management system 105 may access conversion data stored in the data storage 110 in step 410. The insurance management system 105 may then send the response data along with the conversion data to the data conversion module 210 for the response data to be converted to the intermediary format in step 415. In step 420 the conversion module converts the response data from the proprietary format associated to the insurance administration system to the intermediary data format. In some embodiments, the communication manager 205 requests the data conversion module 210 to convert the response data from the proprietary data formats to the intermediary data format using the conversion data. The conversion module 210 may use the same mapping, reformatting, conversion, etc. techniques described above to carry on the conversion process of the response data from the proprietary data format to the intermediary data format, using the conversion data stored in the data storage 110. In step 425 the insurance management system 105 may store the converted response data in the data storage 110.

In addition, the communication manager 205 may also present the response data to the user 150 via the user interface 215 in step 430. In some embodiments, the communication manager 205 organizes the response data that is received from the different insurance administration systems 120-135, and presents a summary or a detailed form of the response data to the user 150.

In some embodiments, the user 150 may request list of insurance policy quotations through the user computer 115 and the user interface module 215. In these embodiments, the response data received by the communication manager 205 may include a list containing the information for each of the quotes returned by the insurance administration systems 120-135. As such, each list item may include information, such as the name of the insurance policy, premium, insurance cycle, duration, etc. The user interface module 215 may format the list items to be displayed in a table format. The table format may include table headers that describe each field of information included in each of the items of the list of the response data. Each of the list items of the response data may be listed under the table headers, displaying the relevant fields of information for each of the insurance quote items of the list.

The user interface module 215 may also give the user 150 the ability to select one or more of the returned insurance quotations included in the response data, as displayed in the table format, to be able to obtain additional or more detailed information about each individual quote. For example, in some embodiments the table of insurance quotations may be displayed as within a WWW browser, in Hyper Text Markup Language (HTML) format. Therefore, each row representing an insurance quotation may have an HTML link that, which when clicked by the user 150 may display further information about the quote in a new WWW browser window or a new HTML page.

In other embodiments, and upon the user 150 requesting the retrieval of personal and other insurance preferences information to be displayed and/or edited, the user interface module 215 may display the different data field items included in the response data in a screen of a windows application. The user interface module 215 will fill the fields of a screen designated to displaying personal and/or insurance preferences information. Screen fields may include textboxes, text area fields, dropdown boxes, select list boxes, display fields, etc. The type of the display field will depend on the type of the data field presented. For example, fields including first names, last names, middle names, street address, city, etc., may be displayed within text fields. Other fields, including state information, area code information, insurance product lists, gender, marital status, etc., may be displayed as dropdown or select list fields. The user 150 may be able to modify some of the displayed fields, thereupon the user interface module 215 may include methods for the user 150 to commit any changes made to the displayed data. The screen may include button fields labeled save, delete, cancel, etc. that may perform corresponding functions as per the displayed names.

In yet other embodiments, the user 150 may be requesting information related to health risk assessments, etc. based on geographical areas or other criteria. The response data may then include graphical information related to the area assessed, along with color coding representing the level of health risk estimates for each sub area. The user interface module 215 may display a graphical map to the user 150, including the risk data, represented by a color coding scheme. This graphical display may be presented to the user 150 within a WWW browser, Microsoft Windows desktop application, etc. Additionally, the user interface module 215 may give the user 150 the ability to export response data, in many forms including a plain text file format, Microsoft Word® document file format, Portable Document Format® (PDF) file format, generic XML file format etc.

It should be apparent to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc.

What is claimed is:

1. A method for interfacing with a plurality of insurance administration systems:
receiving insurance data from a customer;
storing the insurance data in an intermediary format;
interfacing with the plurality of insurance administration systems by automatically (i) converting the insurance data from the intermediary format to a plurality of different proprietary formats, each of the plurality of different proprietary formats corresponding to a different insurance administration system and (ii) sending the insurance data to the plurality of insurance administration systems in their corresponding formats.

2. The method of claim 1, wherein the intermediary format is a JavaScript Object Notation (JSON) format.

3. The method of claim 1, wherein the intermediary format is an Extensible Markup Language (XML) format.

4. The method of claim 1, wherein each of the insurance administration systems is associated with a different insurance carrier.

5. The method of claim 4, wherein at least one of the insurance administration systems comprises an insurance quoting engine for obtaining quotations of the associated carrier's insurance policies.

6. The method of claim 1, wherein at least one of the insurance administration systems comprises a customer relationship management system.

7. The method of claim 1, wherein at least one of the insurance administration systems comprises an insurance underwriting system.

8. The method of claim 1, wherein converting the insurance data comprises appending a subset of insurance data to another subset of insurance data.

9. The method of claim 1, wherein converting the insurance data comprises rearranging an order of the insurance data.

10. The method of claim 1, wherein the insurance data is received from a remote device over a network.

11. The method of claim 1, wherein the insurance data is received in a generic format.

12. The method of claim 1, further comprising automatically querying a set of relevant insurance products from the plurality of insurance administration systems based on the insurance data received from the customer.

13. The method of claim 1, wherein the insurance data comprises information related to the customer's preferences on insurance products.

14. A system for interfacing with a plurality of insurance administration systems:
a data storage;
a network interface configured to communicate with a plurality of insurance administration systems; and
a processor coupled with the data storage and the network interface, the processor configured to (i) store insurance data received from customers in the data storage in an intermediary format, (ii) automatically convert the insurance data from the intermediary format to a plurality of different proprietary formats, each of the plurality of different proprietary formats corresponding to a different insurance administration system in the plurality of insurance administration systems, and (iii) send the insurance data to the plurality of insurance administration systems in their corresponding propriety formats via the network interface.

15. The system of claim 14, wherein the intermediary format is a JavaScript Object Notation (JSON) format.

16. The system of claim 14, wherein the intermediary format is an Extensible Markup Language (XML) format.

17. The system of claim 14, wherein each of the insurance administration systems is associated with a different insurance carrier.

18. The system of claim 17, wherein at least one of the insurance administration systems comprises an insurance quoting engine for obtaining quotations of the associated carrier's insurance policies.

19. The system of claim 14, wherein the processor is further configured to convert the insurance data by appending a subset of insurance data to another subset of insurance data.

20. The system of claim 14, wherein the processor is further configured to convert the insurance data by rearranging an order of the insurance data.

21. The system of claim 14, wherein the insurance data is received from a remote device over a network.

22. The system of claim 14, wherein the insurance data is received in a generic format.

23. The system of claim 14, wherein the processor is further configured to automatically query a set of relevant insurance products from the plurality of insurance administration systems based on the insurance data received from the customer.

24. The system of claim 14, wherein the insurance data comprises information related to the customer's preferences on insurance products.
